(19) United States
(12) Patent Application Publication
(10) Pub. No.: US 2026/0167345 A1
(43) Pub. Date: Jun. 18, 2026

(54) AIRCRAFT FUSELAGE AND METHOD FOR RELEASING A FUEL TANK FROM INSIDE THE AIRCRAFT FUSELAGE IN CASE OF EMERGENCY AS WELL AS AIRCRAFT

(71) Applicant: Airbus Operations GmbH, Hamburg (DE)

(72) Inventors: Matthias Hegenbart, Hamburg (DE); Hermann Benthien, Hamburg (DE)

(21) Appl. No.: 18/889,756

(22) Filed: Sep. 19, 2024

(30) Foreign Application Priority Data
Sep. 28, 2023 (EP) 23200509.0

(51) Int. Cl. B64D 37/04; B64C 1/14; B64D 37/10

(52) U.S. Cl. CPC B64D 37/12; B64C 1/143; B64D 37/10; B64D 37/04

(57) ABSTRACT

An aircraft fuselage for releasing a fuel tank from inside the aircraft fuselage in case of emergency includes an outer structure, a mounting device to releasably secure a fuel tank in an inside of the outer structure, and an openable release door which separates the inside from an outside of the outer structure, wherein the release door is positioned in relation to the mounting device such that the fuel tank is released through the release door when the mounting device releases the fuel tank. A method is disclosed for releasing a fuel tank from inside the aircraft fuselage in case of emergency as well as an aircraft comprising such an aircraft fuselage.

### TECHNICAL FIELD

The disclosure herein relates to a device as well as to an aircraft fuselage for releasing a fuel tank from inside the aircraft fuselage in case of emergency. The disclosure herein is furthermore concerned with an aircraft containing such an aircraft fuselage and a method for releasing a fuel tank from inside an aircraft fuselage in case of emergency.

### BACKGROUND

It is very often necessary, especially on long range flights, for an aircraft to carry an additional supply of fuel to that normally required and installed in the aircraft. Such an additional fuel is generally carried in additional tanks on the outside of the aircraft, or, more particularly, for convenience and aerodynamic reasons, may be attached to the lower surface of the wing section. These tanks can be released or dropped off, thus reducing the load and drag factor on the aircraft or for safety reasons.

Various types of jettisonable fuel tank arrangements are known. Most prior art types of jettisonable fuel tank arrangements have been so constructed and located with respect to the aircraft body or fuselage as to provide a generally aerodynamically smooth, streamlined outer surface to the aircraft.

Typically, the jettisonable fuel tank is connected to a reserve fuel tank means carried by the aircraft, and wherein the valve means serves to normally maintain open fuel flow communication between the jettisonable fuel tank and the engine of the aircraft.

For example U.S. Pat. No. 4,306,693 describes an improved fuel tank system for aircraft, and more particularly, to jettisonable fuel tank means and related self-sealing valve means therefor. This jettisonable fuel tank can be dropped when the contained fuel is consumed.

Those known jettisonable fuel tanks may be difficult to be upgraded in existing aircrafts.

### SUMMARY

According to the disclosure herein, this problem is solved in each case by the disclosure herein.

According to a first aspect of the disclosure herein, an aircraft fuselage for releasing a fuel tank from inside the aircraft fuselage in case of emergency is provided. The aircraft fuselage comprises an outer structure and a mounting device. The mounting device is configured to releasably secure a fuel tank in an inside of the outer structure. Moreover, the aircraft fuselage comprises an openable release door which separates the inside from an outside of the outer structure, wherein the release door is positioned in relation to the mounting device such that the fuel tank is released through the release door when the mounting device releases the fuel tank.

According to a second aspect of the disclosure herein, an aircraft comprising an aircraft fuselage according to the first aspect of the disclosure herein is provided. Furthermore, the aircraft comprises a fuel tank which is releasably secured by the mounting device in an inside, for example an inner tank compartment, of the outer structure.

According to a third aspect of the disclosure herein, a method for releasing a fuel tank from inside an aircraft fuselage in case of emergency is provided. The method comprises opening a release door which separates an inside from an outside of an outer structure of an aircraft fuselage. Further, the method comprises disconnecting a fuel tank which is releasably secured by a mounting device in the inside of the outer structure from the mounting device such that the fuel tank releases the aircraft fuselage through the open release door.

A fundamental concept of the disclosure herein is to separate a fuel tank, in particular a liquid hydrogen tank, in case of emergency like a hydrogen leakage, which cannot be stopped. Removing the fuel tank from the aircraft automatically and moving it into a safe distance is enabled. It is emphasized that the disclosure herein can be applied on ground as well as in flight. The fuel tank can be installed anywhere in the aircraft fuselage, for example in the front, in the middle, in the back or in a cargo compartment. In particular, the fuel tank is stored in an inner tank compartment of the outer structure separated from other areas of the aircraft fuselage. The mounting device or tank fitting, respectively, can be integrated in the aircraft fuselage, for example. A system for the separation of the fuel tank, in particular a hydrogen tank separation system, is provided. The fuel tank can have a substantially cylindrical shape or any similar shape.

A particular advantage in the solution according to an aspect of the disclosure herein is that a fuel tank, which usually contains dangerous fluids that are easy flammable or explosive, for example, can operated more safely in an aircraft. When a problem with the fuel tank occurs that cannot be handled in the aircraft, the complete fuel tank can be removed from the aircraft to provide a safe further flight and/or landing.

Another advantage is that hydrogen can be stored in the fuel tank and used as fuel for the aircraft. Since liquid hydrogen can be explosive when combined with air, and only a small amount of energy is required to ignite the hydrogen, the disclosure herein provides a solution to handle it safely, in particular in the event of an emergency.

Advantageous embodiments and further developments emerge from the description with reference to the figures.

According to some aspects of the disclosure herein, the openable release door is positioned on a bottom side of the outer structure. In particular such that the fuel tank drops off the aircraft fuselage by gravity. For example, the release door comprises two drop doors. The release door or the two drop doors, respectively, is located under the fuel tank.

According to some further aspects of the disclosure herein, the mounting device comprises an enclosure which encloses a shell surface of the fuel tank at least sectionwise. That means the shell surface is surrounded by the enclosure completely radially.

Furthermore, the mounting device can fix the fuel tank in a longitudinal axis of the fuel tank. Therefore, the mounting device can comprise an attachment element at a front end region and/or a rear end region of the fuel tank with regard to the longitudinal axis.

According to some further aspects of the disclosure herein, the enclosure comprises a reversible quick release element which locks the enclosure in a secured status and is driven electromechanically, magnetically, hydraulically or pneumatically to open the enclosure. Therefore, the quick release element can be operated automatically and/or semi-automatically. For example, the quick release element is driven by a spindle drive. The quick release element can be located between the fuel tank and the release door. The quick release element releases the enclosure and thus the fuel tank is released.

For example, a hydrogen detection system can be positioned at or coupled to the mounting device and/or the release door that when a hydrogen leak is detected the hydrogen detection system may activate the quick release element and the release door. Furthermore, the quick release element and/or the release door can be activated or controlled by an activation system or a control and steering unit, respectively.

According to some further aspects of the disclosure herein, the enclosure comprises a plurality of chain links that are connected to each other by a locking pin, wherein the reversible quick release element is configured as a reversible quick release pin connecting two of the plurality of chain links. The quick release pin can be driven by a spindle drive to unlock/release the two chain links which are connected by the quick release pin.

According to some further aspects of the disclosure herein, the enclosure is configured as a strap having at least two parts that are connected to each other by the reversible quick release element. For example, the strap can be configured like a belt.

In some embodiments the plurality of chain links can be combined with the strap, wherein the quick release element is provided to release the strap or the plurality of chain links. Further, the enclosure may comprise a bearing block, a rail or similar components for enclosing the fuel tank.

According to some further aspects of the disclosure herein, the openable release door is hinged to the outer structure and opened by a hydraulic, electromechanical or pneumatic pivot mechanism, wherein a hinge axis of the hinged release door is substantially corresponding to a longitudinal axis of the aircraft fuselage. For example, the release door is configured as a conventional landing gear door, wherein its size and functionality is scalable to any demand. Such a demand could be being openable in great heights and/or a maximum flight speed.

Alternatively, the hinge axis of the hinged release door is substantially perpendicular to the longitudinal axis of the aircraft fuselage. The release door can be further equipped with a lock for locking the release door.

According to some further aspects of the disclosure herein, the openable release door is configured reclosable, in particular reclosable during flight. Thus, an aerodynamic property of the aircraft fuselage is not influenced by a protruding release door and/or an uncovered opening.

Optionally, at least a section of the aircraft fuselage can be lined with a fire resistant lining for blocking flames. Alternatively or additionally, at least a section of an inner side of the outer structure can comprise a flame deflector shielding.

According to some further aspects of the disclosure herein, the fuel tank is fluidly connected to a standard fueling and transfer line of the aircraft when secured by the mounting device. The fuel tank supplies an engine of the aircraft with fuel. The fuel tank can be configured as a cryogenic tank for storing hydrogen or other cryogenic fluids. The standard fueling and transfer line may be coupled to the fuel tank in its front end region or rear end region. For example, the front end region corresponds to a front end of a cylindrical shaped fuel tank.

According to some further aspects of the disclosure herein, the aircraft further comprises a second fuel tank which is independent from the fuel tank and integrated into a wing of the aircraft.

Optionally, the aircraft can comprise a hybrid engine which is configured to be driven by different fuels that are supplied from the fuel tank and the second fuel tank via the standard fueling and transfer line. The fuel tank can store hydrogen and the second fuel tank can store kerosine, for example. Alternatively, the fuel tank and the second fuel tank can store the same fuel.

According to some further aspects of the disclosure herein, the method further comprises closing the release door after the fuel tank has released the aircraft fuselage. In particular, the release door is closed during flight with a regular flight speed or with a reduced flight speed. Furthermore, the release door can be closed in any desired altitude.

According to some further aspects of the disclosure herein, the fuel tank drops off the aircraft fuselage through the open release door by a gravity force. Thus, the fuel tank can separate downward away from the aircraft fuselage. The open release door may comprise two drop doors. The drop doors are driven in full open position, for instance.

Additionally, the step of disconnecting may comprise activating a shut off valve for fluidly closing the fuel tank and the standard fueling and transfer line.

According to some further aspects of the disclosure herein, the method further comprises switching a fuel supply from the fuel tank to a second fuel tank which is independent from the fuel tank and not to be released.

Optionally, the method could start with a step of detecting a leakage of the fuel tank. The leakage can be detected by a user or a hydrogen detection system positioned at or coupled to the fuel tank, for example.

### BRIEF DESCRIPTION OF THE DRAWINGS

The disclosure herein is explained more specifically below on the basis of the example embodiments indicated in the schematic figures, in which:

FIG. 1 shows a schematic illustration of an aircraft fuselage for releasing a fuel tank from inside the aircraft fuselage in case of emergency according to an embodiment of the disclosure herein;

FIG. 2 shows a schematic illustration of the aircraft fuselage according to FIG. 1 with an opened release door and a secured mounting device;

FIG. 3 shows a schematic illustration of the aircraft fuselage according to FIGS. 1 and 2 with an opened release door and a released mounting device;

FIG. 4 shows a schematic illustration of the aircraft fuselage according to FIGS. 1, 2 and 3 with a reclosed release door;

FIG. 5 shows a schematic illustration of an aircraft according to a further embodiment of the disclosure herein; and

FIG. 6 shows a flow chart for a method for releasing a fuel tank from inside the aircraft fuselage in case of emergency according to a further embodiment of the disclosure herein.

### DETAILED DESCRIPTION

The accompanying figures are intended to convey a further understanding of the embodiments of the disclosure herein. They illustrate embodiments and are used in conjunction with the description to explain principles and concepts of the disclosure herein. Other embodiments and many of the cited advantages emerge in light of the drawings. The elements of the drawings are not necessarily shown to scale in relation to one another. Direction-indicating terminology such as for example “at the top”, “at the bottom”, “on the left”, “on the right”, “above”, “below”, “horizontally”, “vertically”, “at the front”, “at the rear” and similar statements are merely used for explanatory purposes and do not serve to restrict the generality to specific configurations as shown in the figures.

In the figures of the drawing, elements, features and components that are the same, have the same function and have the same effect are each provided with the same reference signs-unless explained otherwise.

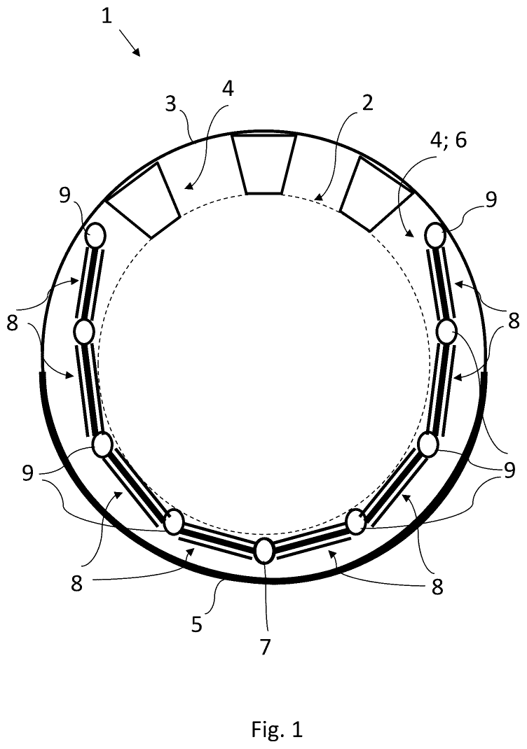

FIGS. 1, 2, 3 and 4 show a schematic illustration of an aircraft fuselage 1 for releasing a fuel tank 2 from inside the aircraft fuselage 1 in case of emergency according to an embodiment of the disclosure herein.

The aircraft fuselage 1 comprises an outer structure 3, a mounting device 4, an openable release door 5, an enclosure 6 and a reversible quick release element 7. The outer structure 3 can include a frame and a stringer.

The mounting device 4 or tank fitting, respectively, is configured to releasably secure a fuel tank 2 in an inside, in particular an inner tank compartment, of the outer structure 3. The tank fitting 4 comprises the enclosure 6 which encloses a shell surface of the fuel tank 2 at least sectionwise, here the lower and lateral section. Furthermore, the tank fitting 4 comprises three pads. The upper section of the fuel tank 2 is enclosed sectionwise by the three pads.

Moreover, the enclosure 6 comprises the reversible quick release element 7 which locks the enclosure 6 in a secured status and is driven electromechanically, or hydraulically to open the enclosure 6. Therefore, the quick release element 7 can be operated semi-automatically. For example, a hydrogen detection system (not shown) can be positioned at or coupled to the tank fitting 4 and/or the release door 5 that when a hydrogen leak is detected the hydrogen detection system may activate a signal for informing a pilot. The quick release element 7 and the release door 5 can be activated by the pilot. After activation by the pilot the fuel tank 2 is automatically released through the release door 5.

Exemplarily, the enclosure 6 comprises a plurality of chain links 8 and a plurality of locking pins 9. The plurality of chain links 8 are connected to each other by the locking pin 9. The reversible quick release element 7 is configured as a reversible quick release pin connecting two of the plurality of chain links 8. Here, the quick release pin 7 is arranged at the lowest point of the tank fitting 4. In other words, the quick release pin 7 is arranged in the middle of the release door 5, for example.

The openable release door 5 separates the inner tank compartment from an outside of the outer structure 3. Here, the release door 5 consists of two door parts. The two door parts can be configured as a double door. The release door 5 is positioned in relation to the mounting device 4 such that the fuel tank is released through the release door 5 when the mounting device 4 releases the fuel tank 2. Exemplarily, the two door parts form a quarter of the aircraft fuselage 1 each. Thus, the release door 5 extends over the lower half of the aircraft fuselage 1 with regard to a cross-section view.

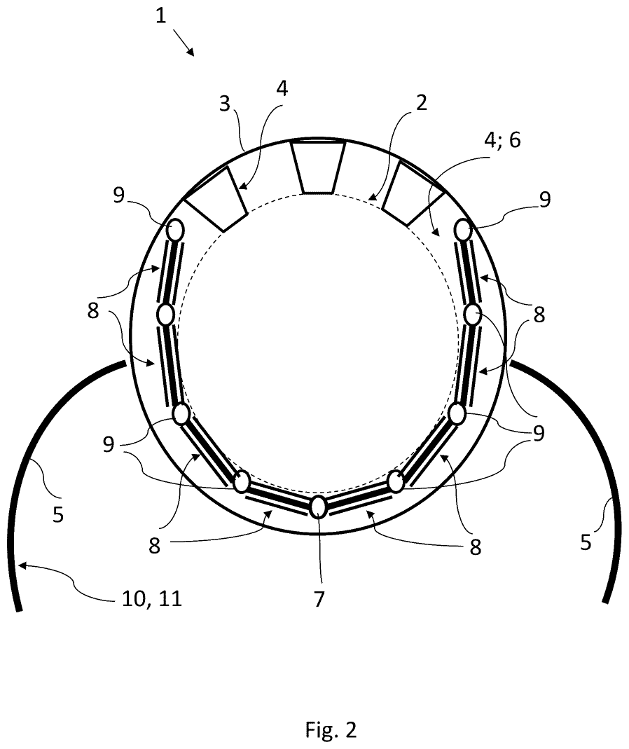

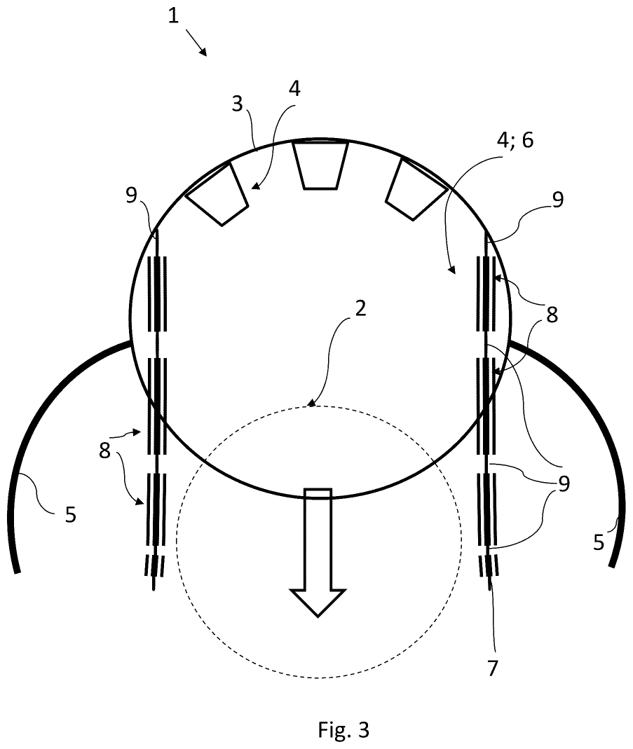

Here, the openable release door 5 is positioned on a bottom side 3a of the outer structure 3, in FIGS. 2 and 3 it corresponds to the lower side of the outer structure 3, such that the fuel tank 2 drops off the aircraft fuselage 1 by gravity. Thereby, the openable release door 5 is hinged to the outer structure 3 and opened by a hydraulic pivot mechanism. In FIGS. 2 and 3, the release door 5 is illustrated in a fully open status. A hinge axis of the hinged release door 5 is substantially corresponding to the longitudinal axis of the aircraft fuselage 1. In particular, the release door 5 is configured as a conventional landing gear door, wherein its size and functionality is scalable to any demand. In this example, the release door 5 is hinged at an upper section of the release door 5 such that the release door 5 opens sidewards.

In FIG. 2 the aircraft fuselage 1 is schematically illustrated with an opened release door 5 and a secured mounting device 4. The aircraft fuselage 1 of FIG. 2 differs from the aircraft fuselage 1 of FIG. 1 in that a section of the aircraft fuselage 1 is lined with a fire resistant lining 10 for retaining flames and a section of an inner side of the outer structure 3 comprises a flame deflector shielding 11. In particular, these section correspond to an inner side of the first 5 and second release door 9 as well as the walls that surround the fuel tank 2, for example the inner walls of the inner tank compartment.

FIG. 3 shows the aircraft fuselage 1 according to FIGS. 1 and 2 with an opened release door 5 and a released tank fitting 4.

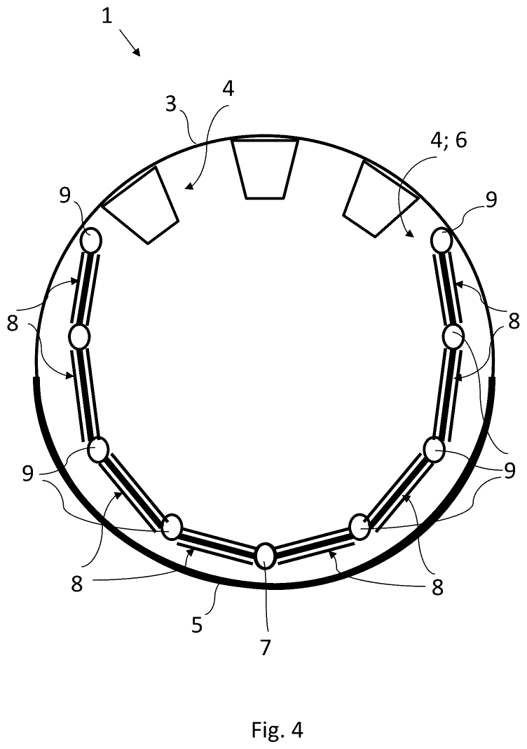

The openable release door 5 is configured reclosable, in particular reclosable during flight. Thus, an aerodynamic property of the aircraft fuselage 1 is not influenced by a protruding release door 5 and/or an uncovered opening as it is present in FIGS. 2 and 3. In FIG. 4 the aircraft fuselage according to FIGS. 1, 2 and 3 is shown with a reclosed release door 5.

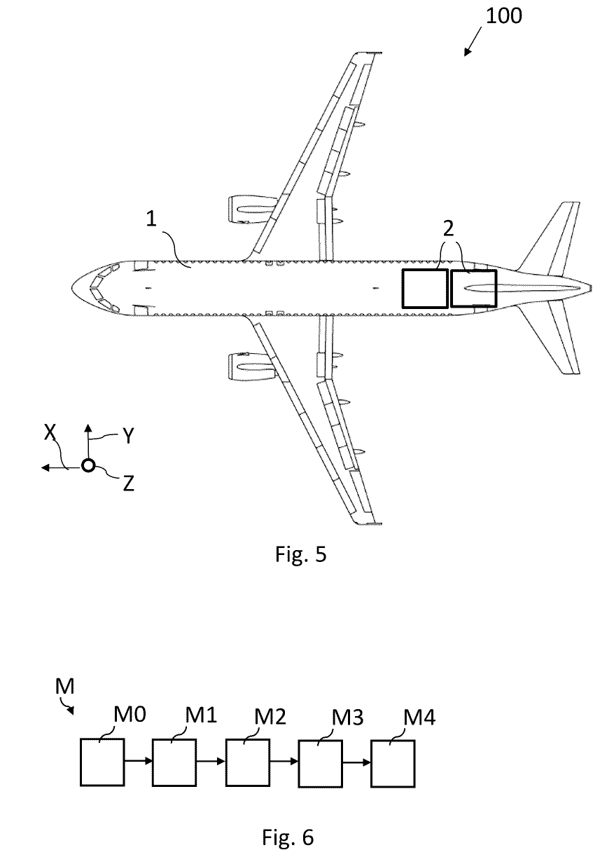

FIG. 5 shows a schematic illustration of an aircraft 100 according to a further embodiment of the disclosure herein. Specifically, the aircraft 100 is configured as a passenger or cargo aircraft.

The aircraft 100 comprises an aircraft fuselage, in particular an aircraft fuselage 1 according to FIG. 1, 2, 3 or 4, and two fuel tanks 2. Each fuel tank 2 is releasably secured by the mounting device 4 in an inside, in particular in an inner tank compartment, of the outer structure 3. The openable releasable door 5 is located on a bottom side of the aircraft fuselage 1.

Here, the aircraft 100 comprises two fuel tanks 2 but is not limited to that number. The aircraft 100 can also comprise one, three or more fuel tanks 2. For example, the three or more fuel tanks are arranged behind each other and/or next to each other such that each fuel tank 2 can be released from the aircraft fuselage 1 individually.

The two fuel tanks 2 are fluidly connected to a standard fueling and transfer line of the aircraft 100 when secured by the mounting device 4. The two fuel tanks supply an engine of the aircraft 100 with fuel. The fuel can be kerosene or hydrogen, for example. Therefore, the fuel tank may be configured as a cryogenic tank for storing hydrogen.

Further, the aircraft 100 comprises a second fuel tank which is independent from the two fuel tanks and integrated into a wing of the aircraft 100. The second fuel tank is configured for storing kerosene, for example. The two fuel tanks 2 can store hydrogen and the second fuel tank can store kerosene, for example. Alternatively, the two fuel tanks and the second fuel tank store the same fuel.

FIG. 6 shows a flow chart for a method M for releasing a fuel tank from inside the aircraft fuselage in case of emergency according to a further embodiment of the disclosure herein. In particular, the fuel tank 2 is released from inside the aircraft fuselage 1 according to FIG. 1, 2, 3 or 4.

The method M comprises the steps of detecting M0, switching M1, opening M2, disconnecting M3 and closing M4.

The method M could start with detecting M0 a leakage of the fuel tank 2. The leakage can be detected by a user or a hydrogen detection system positioned at or coupled to the fuel tank 2.

In the optional step of switching M1 a fuel supply from the fuel tank 2 is switched to a second fuel tank which is independent from the fuel tank 2. Thereby, the second fuel tank is not to be released. Of course, the fuel supply does not need to be switched from the fuel tank 2 to the second fuel tank when the fuel tank 2 does not supply fuel at the moment of starting the method M.

In the step of opening M2 a release door 5 is opened. The release door 5 separates an inside from an outside of an outer structure 3 of the aircraft fuselage 1. For example, the hydrogen detection system may activate the quick release element and the release door. Furthermore, the quick release element and/or the release door can be activated or controlled by an activation system or a control and steering unit, respectively.

In the step of disconnecting M3 the fuel tank 2 is disconnected. The fuel tank 2 is releasably secured by a mounting device 4 in the inside of the outer structure 3 from the mounting device 4 such that the fuel tank 2 releases the aircraft fuselage 1 through the open release door 5. In particular, the fuel tank 2 drops off the aircraft fuselage 1 through the open release door 5 by a gravity force. Thus, the fuel tank 2 can separate downward away from the aircraft fuselage 1.

In the further step of closing M4 the release door 5 is re-closed after the fuel tank 2 has released the aircraft fuselage 1. In particular, the release door 5 is closed during flight with a regular flight speed. Furthermore, the release door 5 can be closed in any desired altitude. Therefore, a drive mechanism of the release door 5 is designed to overcome the higher loads.

In the detailed description above, various features have been combined in one or more examples in order to improve the rigorousness of the illustration. However, it should be clear in this case that the above description is of merely illustrative but in no way restrictive nature. It serves to cover all alternatives, modifications and equivalents of the various features and example embodiments. Many other examples will be immediately and directly clear to a person skilled in the art on the basis of his knowledge in the art in consideration of the above description.

While at least one example embodiment of the present invention(s) is disclosed herein, it should be understood that modifications, substitutions and alternatives may be apparent to one of ordinary skill in the art and can be made without departing from the scope of this disclosure. This disclosure is intended to cover any adaptations or variations of the example embodiment(s). In addition, in this disclosure, the terms “comprise” or “comprising” do not exclude other elements or steps, the terms “a” or “one” do not exclude a plural number, and the term “or” means either or both. Furthermore, characteristics or steps which have been described may also be used in combination with other characteristics or steps and in any order unless the disclosure or context suggests otherwise. This disclosure hereby incorporates by reference the complete disclosure of any patent or application from which it claims benefit or priority.

### REFERENCE LIST

1 device
2 fuel tank
3 outer structure
3a bottom side
4 mounting device
5 release door
6 enclosure
7 reversible quick release element
8 plurality of chain links
9 locking pin
10 fire resistant lining
11 flame deflector shielding
100 aircraft
X longitudinal axis
M method
M0 detecting
M1 switching
M2 opening
M3 disconnecting
M4 closing

1. An aircraft fuselage for releasing a fuel tank from inside the aircraft fuselage in case of emergency, the aircraft fuselage comprising:
an outer structure;
a mounting device configured to releasably secure a fuel tank in an inside of the outer structure; and
an openable release door which separates the inside from an outside of the outer structure, wherein the release door is positioned in relation to the mounting device such that the fuel tank is released through the release door when the mounting device releases the fuel tank.

2. The aircraft fuselage according to claim 1, wherein the openable release door is positioned on a bottom side of the outer structure.

3. The aircraft fuselage according to claim 1, wherein the mounting device comprises an enclosure which encloses a shell surface of the fuel tank at least sectionwise.

4. The aircraft fuselage according to claim 3, wherein the enclosure comprises a reversible quick release element which locks the enclosure in a secured status and is driven electromechanically, magnetically, hydraulically or pneumatically to open the enclosure.

5. The aircraft fuselage according to claim 4, wherein the enclosure comprises a plurality of chain links connected to each other by a locking pin, wherein the reversible quick release element is configured as a reversible quick release pin connecting two of the plurality of chain links.

6. The aircraft fuselage according to claim 4, wherein the enclosure is configured as a strap having at least two parts that are connected to each other by the reversible quick release element.

7. The aircraft fuselage according to claim 1, wherein the openable release door is hinged to the outer structure and can be opened by a hydraulic, electromechanical or pneumatic pivot mechanism, wherein a hinge axis of the hinged release door is substantially corresponding to a longitudinal axis of the aircraft fuselage.

8. The aircraft fuselage according to claim 1, wherein the openable release door is configured reclosable, or reclosable during flight.

9. An aircraft, passenger or cargo aircraft, comprising:
the aircraft fuselage according to claim 1; and
a fuel tank which is releasably secured by the mounting device in an inside of the outer structure.

10. The aircraft according to claim 9, wherein the fuel tank is fluidly connected to a standard fueling and transfer line of the aircraft when secured by the mounting device.

11. The aircraft according to claim 9, further comprising a second fuel tank which is independent from the fuel tank and integrated into a wing of the aircraft.

12. A method for releasing a fuel tank from inside of the aircraft fuselage of claim 1, in case of emergency, the method comprising:
opening a release door which separates an inside from an outside of an outer structure of an aircraft fuselage; and
disconnecting a fuel tank which is releasably secured by a mounting device in the inside of the outer structure from the mounting device such that the fuel tank releases the aircraft fuselage through the open release door.

13. The method according to claim 12, further comprising closing the release door after the fuel tank has released the aircraft fuselage.

14. The method according to claim 12, wherein the fuel tank drops off the aircraft fuselage through the open release door by a gravity force.

15. The method according to claim 12, further comprising switching a fuel supply from the fuel tank to a second fuel tank which is independent from the fuel tank and not to be released.
